(19) United States
(12) Patent Application Publication
(10) Pub. No.: US 2026/0335829 A1
(43) Pub. Date: Oct. 29, 2026

(54) Reverse Osmosis Pump Incorporating Variable Rejection Piston Design

(71) Applicant: Aqua Research, Inc., Albuquerque, NM (US)

(72) Inventors: Rodney E. Herrington, Albuquerque, NM (US); Kevin Roderick, Albuquerque, NM (US); Nate Jones, Albuquerque, NM (US); Kendall Weingardt, Albuquerque, NM (US); Charles Call, Albuquerque, NM (US)

(21) Appl. No.: 19/462,396

(22) Filed: Jan. 28, 2026

Related U.S. Application Data
(63) Continuation-in-part of application No. 18/323,184, filed on May 24, 2023, now abandoned.
Application No. 18/323,184 is a continuation of application No. 16/603,108, filed on Apr. 11, 2018, now abandoned.
(60) Provisional application No. 62/484,591, filed on Apr. 12, 2017.

(51) Int. Cl. B01D 61/10; B01D 61/02; C02F 1/44; F04B 9/105; F04B 13/00; F04B 53/14

(52) U.S. Cl. CPC B01D 61/10; B01D 61/025; C02F 1/441; F04B 9/105; F04B 13/00; F04B 53/14; B01D 2313/243

(57) ABSTRACT

A fluid treatment system, for example a membrane filtration system, utilizing means to mechanically vary fluid recovery and energy recovery to optimize fluid production for a given energy input, based on the total dissolved solids concentration in the fluid feed stream.

### TECHNICAL FIELD

The present invention is directed to a pump apparatus and, particularly, to a pump apparatus for filtering or separation a liquid, for example by reverse osmosis.

### BACKGROUND ART

Filtration of liquids to remove particulates, suspended solids, dissolved solids, and ions requires energy input to force the liquid through the filtration media. While normal filtration by physical exclusion of particles from a solute can theoretically be nearly completely efficient, the minimum energy required to overcome the osmotic pressure of the solute in reverse osmosis (RO) filtration is nonzero and determined by the osmotic pressure of the solute and the volume to be filtered. Practically the energy required is even higher depending on the recovery ratio, the ratio of permeate produced to the total water treated, since the more the remaining reject water is concentrated, the higher the average osmotic pressure required to overcome increases. The higher the recovery ratio, the higher the energy required to produce a given amount of permeate.

As the flow rate of permeate through a RO membrane is proportional to the difference between the applied pressure and the osmotic pressure of the solute, higher pressures are typically used. A pressure control valve is typically used to regulate the outlet pressure. The pressure required at the pressure control valve is typically higher than the osmotic pressure required at the outlet of the membrane to produce continued flow through the membrane at the outlet. Because of this, the difference between the set pressure of the pressure control valve and the osmotic pressure of the concentrated outlet flow results in energy loss as the concentrate exits the pressure control valve. Various energy recovery systems, including rotating doors and turbine or pump systems have been developed in order to use this lost energy to pre-pressurize the incoming solvent in order that it not be wasted.

Both Wanner, Sr., et al, and Herrington, disclose hand-held reverse osmosis systems which energy recovery by transferring energy from the concentrated outlet solution to the new solute coming into the system. Both of these systems use the design of the piston/plunger which is used to pump the inlet solute through the membrane to determine both the recovery ratio and the amount of energy recovered by energy exchange. Pressurized concentrate from the outlet of the membrane is fed to the area of the pump cylinder behind the piston in order to pressurize the back side of the piston and reduce the external energy input to the pump. In each case, the ratio of the volume of the area behind the pump cylinder fully compressed to the inlet area pump cylinder with the pump fully retracted determines the rejection ratio. Since these relative volumes are fixed by the piston and cylinder geometry, the energy recovery is also fixed by the piston design.

A shortcoming of these designs is that the fixed recovery ratio and energy recovery limit the efficiency and usefulness for a device with a fixed power source, such as a human powered device, to a fixed range of solute osmotic pressure. Solute osmotic pressure lower than the design pressure will result in less pumping effort with less than optimal permeate output, while solute osmotic pressure higher than the design pressure will require more power input than a fixed source can produce.

Filtration of saline water is an important application of reverse osmosis to create drinkable water from a variety of sources. Reverse osmosis is an effective means for removing salts and other ions, and is also used for the physical exclusion of particulates and suspended solids to provide drinkable permeate water. Water used as a source to produce drinking water can range in salinity anywhere from higher than that of seawater, which has a salinity of about 3.5%, to brackish water sources, to fresh water which is physically contaminated with microorganisms, particles, or chemical compounds which it is desirable to remove. Using a fixed recovery ratio and energy recovery in a filtration system limits optimal filtration across the range of potential water sources.

### DISCLOSURE OF INVENTION

Embodiments of the present invention provide a reciprocating piston pump for use in a reverse osmosis system, comprising a chamber, a piston slidable within the chamber, and a first element that can be configured in a first configuration wherein the piston has a first cross-sectional area receiving pressure, and second configuration wherein the piston has a second cross-sectional area receiving pressure, where the second cross-sectional area is different that the first cross-sectional area.

The pump can further comprise a shaft that moves with the piston, and wherein the first element comprises a sleeve concentric with the shaft, and in the first configuration the shaft slides through the sleeve and the sleeve is not in contact with the piston, and in the second configuration the sleeve slides with the shaft and the sleeve is in contact with the piston.

The pump can further comprise a second element that can be configured in a first configuration wherein the piston has a third cross-sectional area receiving pressure, and second configuration wherein the piston has a fourth cross-sectional area receiving pressure, where the first, second, and fourth cross-sectional areas are different from each other.

The pump can further comprise a shaft mounted with the chamber and the piston such that the shaft can slide into and out of the chamber, and such that such sliding motion of the shaft corresponds to sliding motion of the piston within the chamber, wherein the shaft has a cross-sectional area that is configurable to at least two distinct values.

Embodiments of the invention provide a reciprocating piston pump for use in a reverse osmosis system, comprising a chamber element defining an interior volume; a first piston subsystem configured to slidably engage the interior volume and separate it into first and second volumes, wherein the first piston subsystem presents a first cross-sectional area to the first volume; and a second piston subsystem configured to slidably engage the interior volume and separate it into first and second volumes, wherein the second piston subsystem presents a second cross-sectional area to the first volume; wherein the first cross-sectional area is different than the second cross-sectional area.

In some embodiments, the first piston subsystem comprises a first piston, a first shaft, and a first sealing member, wherein the first sealing member is configured to sealingly mount with the chamber element, the first piston is configured to slidably engage the interior volume, and together with the first sealing member define the first volume, wherein the first shaft is configured to slide through the first sealing member and to engage the piston such that sliding motion of the first shaft imparts sliding motion of the piston relative to the chamber element, wherein the first shaft has a first shaft cross-sectional area; and wherein the second piston system comprises a second piston, a second shaft, and a second sealing member, wherein the second sealing member is configured to sealingly mount with the chamber element, the second piston is configured to slidably engage the interior volume, and together with the second sealing member define the first volume, wherein the second shaft is configured to slide through the second sealing member and to engage the piston such that sliding motion of the second shaft imparts sliding motion of the piston relative to the chamber element, wherein the second shaft has a second shaft cross-sectional area; wherein the first shaft cross-sectional area is different than the second shaft cross-sectional area.

In some embodiments, the first piston and the second piston comprise a single piston, used as the first piston in the first piston subsystem and as the second piston in the second piston subsystem.

In some embodiments, the first sealing member and the second sealing member comprise a single sealing member, used as the first sealing member in the first piston subsystem and as the second sealing member in the second piston subsystem.

In some embodiments, the piston divides the chamber into a pumping chamber portion and a driving chamber portion, and further comprising a driving chamber seal mounted with the chamber and sealing the driving chamber portion; and wherein the first element comprises a sleeve mounted extending through the driving chamber seal; and further comprising a shaft extending from the piston through sleeve; wherein in the first configuration the sleeve is engaged with the chamber, the driving chamber seal, or both, and the shaft moves within the sleeve as the piston slides within the chamber, and wherein in the second configuration the sleeve is engaged with the piston, the shaft, or both, and the sleeve moves with the piston as the piston slides within the chamber.

Embodiments of the present invention provide a system for treatment of water, comprising a frame, a reciprocating piston pump as described herein, mounted with the frame; a reverse osmosis element in fluid communication with the pump; and a motor drive configured to drive the pump.

Embodiments of the present invention provide a method of treating water having a first total dissolved solids and water having a second total dissolved solids, comprising providing a reverse osmosis system; providing a pump as described herein, in fluid communication with the reverse osmosis system; configuring the pump for a first recovery ratio when treating water having the first total dissolved solids; and configuring the pump for a second recovery ratio when treating water having the second total dissolved solids.

### BRIEF DESCRIPTION OF DRAWINGS

FIG. 1A is a schematic illustration of an example embodiment of the present invention having a piston shaft with a first cross-sectional area.

FIG. 1B is a schematic illustration of an example embodiment of the present invention having a piston shaft with a second cross-sectional area.

FIG. 2A is a schematic illustration of an example embodiment of the present invention having a piston shaft with a first cross-sectional area, and a sleeve through which the piston moves.

FIG. 2B is a schematic illustration of an example embodiment of the present invention having a piston shaft with a first cross-sectional area and a sleeve that moves with the piston shaft.

FIG. 3A is a schematic illustration of an example embodiment of the present invention having a piston shaft with a first cross-sectional area, and first and second sleeves through which the piston moves.

FIG. 3B is a schematic illustration of an example embodiment of the present invention having a piston shaft with a first cross-sectional area, and a first sleeve that moves with the piston, and a second sleeve through which the piston and first sleeve move.

FIG. 3C is a schematic illustration of an example embodiment of the present invention having a piston shaft with a first cross-sectional area, and first and second sleeves that move with the piston.

FIG. 4A is a schematic illustration of an example embodiment of the present invention having a piston shaft with a first cross-sectional area, and a sleeve through which the piston moves.

FIG. 4B is a schematic illustration of an example embodiment of the present invention having a piston shaft with a first cross-sectional area and a sleeve that moves with the piston shaft.

FIG. 5 is a schematic illustration of an example embodiment.

FIG. 6 is a schematic illustration of an example embodiment.

FIG. 7A and FIG. 7B are schematic illustrations of an example embodiment illustrating coupling of a sleeve to a bushing (FIG. 7A) or a piston shaft (FIG. 7B).

FIG. 8 is an illustration of an example embodiment.

### MODES FOR CARRYING OUT THE INVENTION AND INDUSTRIAL APPLICABILITY

The present invention provides a pumping apparatus with a replaceable or variable piston geometry that can be changed in order to provide recovery ratio and energy recovery in order to provide efficient reverse osmosis filtration for a variety of solute concentrations or total dissolved solids (TDS) concentrations while employing a relatively fixed output power source. The ability to efficiently filter different water sources with a single device is highly advantageous.

While the stroke and diameter of the piston used in the system will fix the volumetric flow pushed through the membrane per stroke, varying the effective diameter of the piston shaft controls the recovery ratio and energy recovery achievable within the system. By employing various different shaft-to-piston cross-sectional area ratios, a pump can be designed to pump with the same energy input while varying the recovery ratio and energy recovery. A very high rejection ratio (high volume of rejection fluid to feed solution) with consequently low energy usage can be employed for a seawater filtration application, while a moderate rejection ratio can be used for brackish water, and a very low rejection can be used to provide larger volumes of permeate of low solute concentration fluid such as fresh water, all of which operate at approximately the same energy input to the pump.

In an example embodiment of the invention, the entire piston and shaft assembly, or simply the piston shaft alone, and the accompanying seal or bushing used to seal the shaft to the pump housing, are replaced in order to change the ratio of the shaft to piston cross sectional area. A larger shaft diameter will result in a lower rejection ratio, while a smaller shaft diameter will result in a higher rejection ratio. The maximum rejection ratio is limited by the physical strength of the shaft needed to drive the piston while pressurizing the solute as it is fed to the membrane. The minimum rejection ratio approaches zero as the diameter of the shaft approaches the diameter of the piston. Various shaft and bushing/seal combinations can be employed in a modular design and swapped out in order to provide various recovery ratios appropriate to the solute to be filtered. In this way, a single filtration device can be used in various situations while only replacing small components which can be swapped in the field. As those skilled in the art know, such systems often have cylindrical shapes to facilitate manufacturing (e.g., forming cylindrical holes is often easier than forming other shapes) and sealing (e.g., O-rings or other seals are often easy to form and manipulate in circular configurations). Other shapes can be used, however, such as rectangular or elliptical, as examples, to suit fabrication and use objectives.

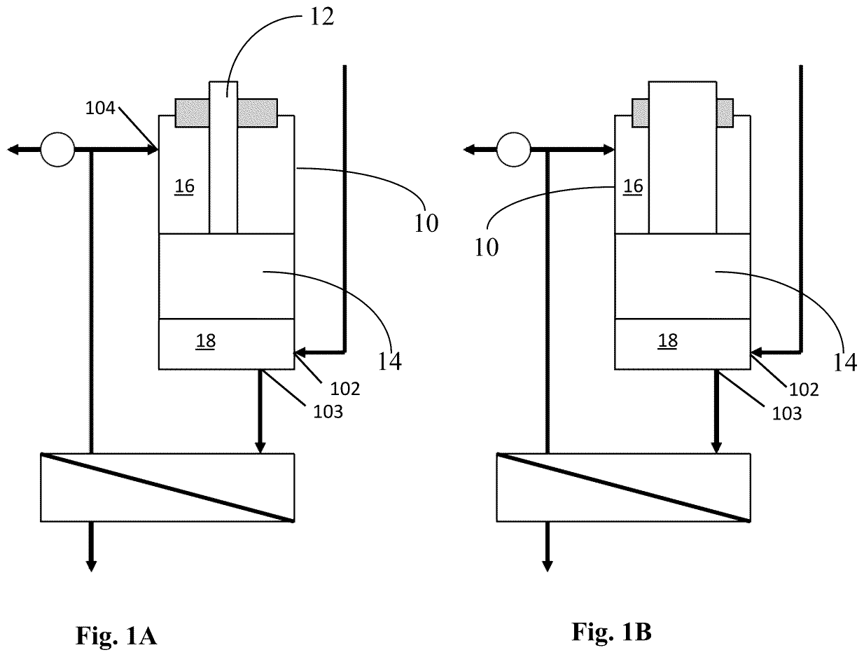

FIG. 1A is a schematic illustration of an example embodiment of the present invention having a piston shaft 12 with a first cross-sectional area. The ratio of the piston diameter 14 to the piston shaft 12 diameter will influence the recovery ratio as described herein. The recovery ratio is determined by the force acting on the piston—upward in the figure from pressurized fluid in the pumping chamber, and downward in the figure from pressurized fluid in the recovery chamber plus force on the shaft. The force due to pressure in the recovery chamber is configured in the present invention—a smaller diameter shaft as in FIG. 1A results in a larger area of the piston 14 exposed to fluid pressure in the recovery chamber and thus a larger recovery force augmenting the force on the shaft; a larger diameter shaft as in FIG. 1B results in a smaller area of the piston 14 exposed to fluid pressure in the recovery chamber and thus a smaller recovery force augmenting the force on the shaft. FIG. 1B is a schematic illustration of an example embodiment of the present invention having a piston shaft 128 with a second cross-sectional area. Since the second cross-sectional area is different than the first cross-sectional area (in FIG. 1A), the recovery ratio of the example of FIG. 1B will be different from that of the example of FIG. 1A, and the pistons and shafts can be selected so that their relative cross-sectional areas provide the desired recovery ratios. As those skilled in the art appreciate, in such a pump fluid to be pumped enters the pumping chamber 101 through a fluid inlet port 102, and pressurized fluid exits the pumping chamber 101 via fluid outlet port 103. Pressurized fluid is then supplied to the recovery chamber 105 through fluid transfer port 104. The recovery ratio, as discussed above, is determined by the area of the piston 14 exposed to the recovery fluid pressure in recovery chamber 105 relative to the area of the piston 14 exposed to the pumping chamber 101. Because the area of the piston 14 exposed to the recovery chamber is determined by the area of the piston 14 less the cross-sectional area of the shaft 12, the cross-sectional area of the shaft 12 effectively determines the recovery ratio. This configuration of fluid ports and the principles of recovery ratio are common to the example embodiments described herein.

In an example embodiment, the design incorporates one or more concentric volumes or shells which can be selectively coupled to the shaft to increase the effective shaft volume. These volumes or shells can either remain uncoupled, allowing the shaft to operate with its minimum volume, or can be coupled, either individually or multiply to increase the effective volume or diameter of the shaft. The volumes or shells can be coupled in various manners, including as example mechanically coupled by means of a locking pin or clip, or another mechanical or electro-mechanical engaging mechanism. Selective coupling of shafts and sleeves is common to several embodiments, allowing such shafts or sleeves to move in concert when coupled, and to move separately (e.g., one fixed to a chamber while the other moves) when uncoupled.

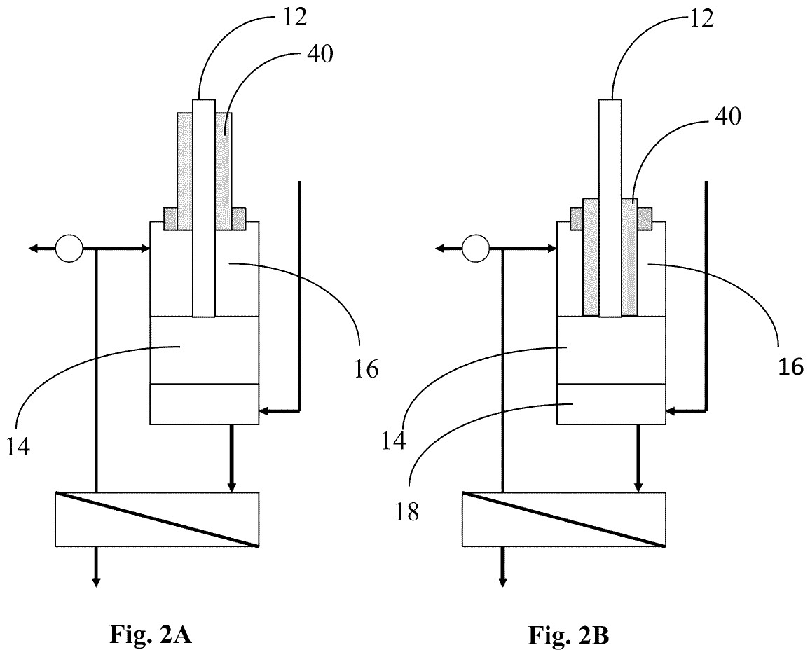

FIG. 2A is a schematic illustration of an example embodiment of the present invention having a piston shaft 12 with a first cross-sectional area, and a sleeve 40 that has an opening therethrough through which the piston shaft 12 moves. E.g., if the piston shaft is cylindrical in its exterior shape, then the sleeve opening can be a cylindrical hollow through the sleeve whose diameter matches the external diameter of the piston shaft 12. The sleeve 40 passes into the chamber through a first end opening in the chamber (where the “chamber” refers to the element that encloses the recovery 16 and pumping chambers 18 with walls surrounding those chambers and first and second ends which, with the walls, form the pumping and recovery chambers). The piston shaft 12 moves with the piston, sliding through the sleeve opening, while the sleeve 40 remains in a position fixed to the chamber (e.g., by a locking element) such that it does not affect the area of the piston 14 exposed to pressure on the top surface in the figure, or the back side of the piston relative to the pumping volume (in the figure, assuming cylindrical pumping and recovery chambers, the concentric circle area between the outside diameter of the piston 14 and outside diameter of the shaft 12). The recovery ratio is thus determined by the relative cross-sectional areas of the piston 14 and the shaft 12. As those skilled in the art appreciate, for proper operation of the pump it is desirable that fluid not leak out of the recovery chamber or the pumping chamber (except through the intended ports). Accordingly, it is desirable that the sleeve 40 substantially seals with the first end opening through which the sleeve 40 passes, and that the piston shaft 12 substantially seals with the internal passage of the sleeve 40 through which the piston shaft 12 moves. The same principle is applicable in other embodiments where shafts or sleeves move relative to each other or to a chamber body.

FIG. 2B is a schematic illustration of an example embodiment of the present invention having a piston shaft 12 with a first cross-sectional area and a sleeve 40 that moves with the piston shaft 12. The sleeve 40 is fixed to the piston shaft 12, e.g., by a locking element, so that the sleeve 40 slides through the first end opening in concert with motion of the piston and piston shaft 12. The sleeve 40 of the example in FIG. 2B reduces the cross-sectional area of the piston 14 that is exposed to pressure in the recovery chamber 16 from the top or back side of the piston 14, and thus the recovery ratio is determined by the relative cross-sectional areas of the piston 14 and the shaft 12 plus sleeve 40. The piston 14, shaft 12, and sleeve 40 can be selected so that the piston/shaft combination provides a recovery ratio desirable for a first operating environment, and the piston 14/shaft 12 plus sleeve 40 combination provides a recovery ratio desirable for a second operating environment. FIG. 2A illustrates the operating configuration where the sleeve is fixed to the chamber such that the sleeve does not slide relative to the chamber.

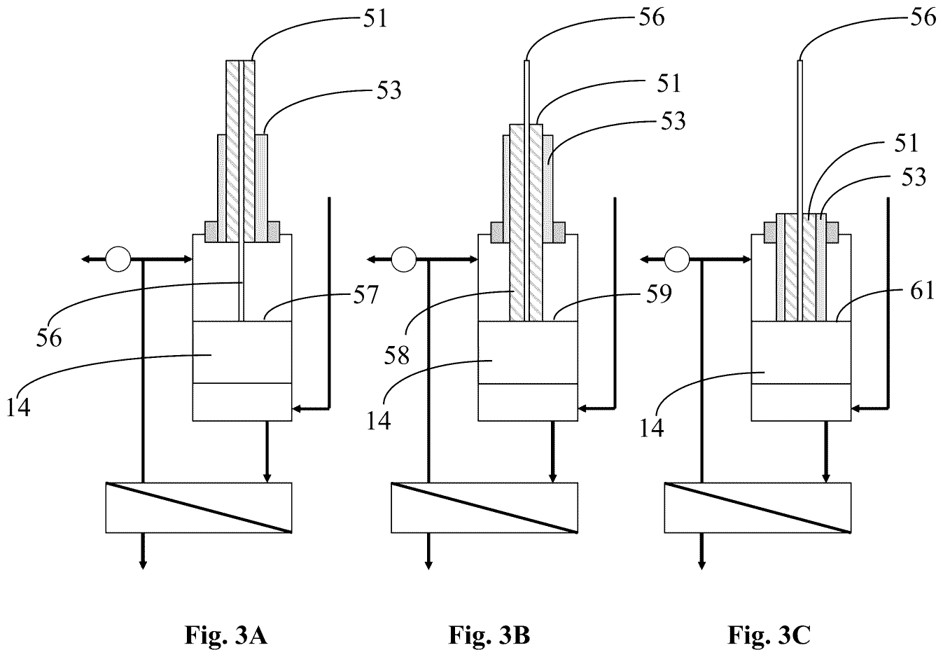

FIG. 3A is a schematic illustration of an example embodiment of the present invention having a piston shaft 56 with a first cross-sectional area, and first 51 and second 53 sleeves through which the piston shaft 56 moves. The piston shaft 56 moves with the piston 14, while the sleeves 51, 53 remain in a position such that neither sleeve affects the area of the piston 14 exposed to pressure on the top surface 57. The recovery ratio is thus determined by the relative cross-sectional areas of the piston 14 and the shaft 56.

FIG. 3B is a schematic illustration of an example embodiment of the present invention having a piston shaft 56 with a first cross-sectional area, and a first sleeve 51 that moves with the piston 14, and a second sleeve 53 through which the piston shaft 56 and first sleeve 51 move. The first sleeve 51 of the example in FIG. 3B reduces the cross-sectional area of the piston 14 that is exposed to pressure from the top 59, and thus the recovery ratio is determined by the relative cross-sectional areas of the piston 14 and the shaft 56 plus first sleeve 51.

FIG. 3C is a schematic illustration of an example embodiment of the present invention having a piston shaft 56 with a first cross-sectional area, and first and second sleeves 51, 53 that move with the piston 14. The first and second sleeves 51, 53 of the example in FIG. 3C reduce the cross-sectional area of the piston 14 that is exposed to pressure from the top 61, and thus the recovery ratio is determined by the relative cross-sectional areas of the piston 14 and the shaft 56 plus first sleeve 51 plus second sleeve 53. The piston 14, shaft 56, and sleeves 51, 53 can be selected so that the piston 14/shaft 56 combination provides a recovery ratio desirable for a first operating environment, and the piston 14/shaft 56 plus first sleeve 51 combination provides a recovery ratio desirable for a second operating environment, and the piston 14/shaft 56 plus first sleeve 51 plus second sleeve 53 combination provides a recovery ratio desirable for a third operating environment. Other example embodiments can incorporate other numbers of sleeves, selectively coupled to provide a variety of recovery ratios.

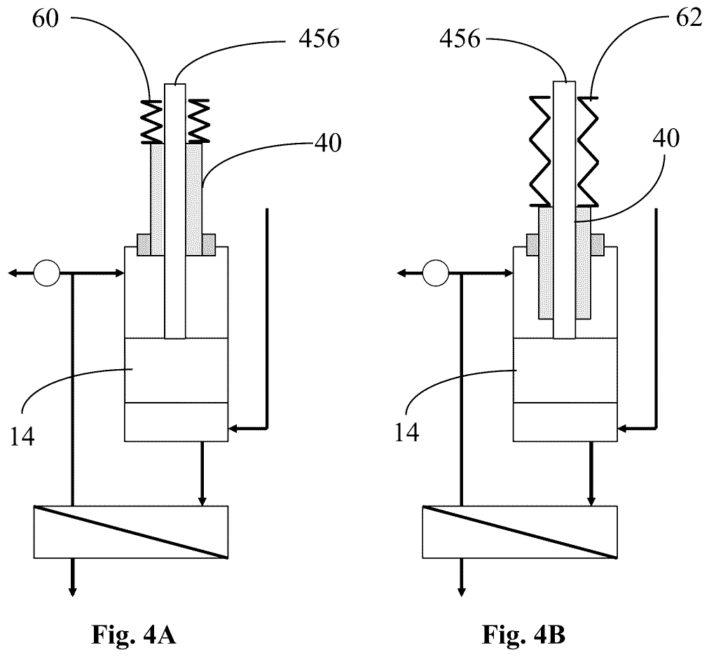

In an example embodiment, e.g., in FIG. 4A and FIG. 4B, the volumes or shells sleeves can also be coupled by spring 60, 62 or pressure, actuated by pressure differential such that when high pressure is applied to the back of the piston 14, the spring 60, 62 or pressurization keeps the volumes or sleeves in place and the effective piston diameter is minimized giving a high rejection ratio, as in the case of seawater filtration. When low pressure exists on the back side of the piston 14 during operation, as in the case of low solute concentration fluid such as fresh water, the volumes or sleeves can extend and cause the rejection ratio to decrease, causing more of the solute to be forced through the membrane and increasing the output for the same input energy. In one embodiment, the piston 14 may not rise fully in the piston cylinder so that the applied pressure would be experienced by the volumes or shells or sleeves to allow for the pressure actuation.

FIG. 4A is a schematic illustration of an example embodiment of the present invention having a piston shaft 456 with a first cross-sectional area, and a sleeve 40 through which the piston shaft 456 moves. FIG. 4B is a schematic illustration of an example embodiment of the present invention having a piston shaft 456 with a first cross-sectional area and a sleeve 40 that moves with the piston shaft 456.

In each embodiment, it should be noted that the pressure relief valve can also be adjusted or replaced to compensate and allow maximum energy recovery for each configuration. It is noted that any type of movable sections that can be coupled to the motion of the shaft can be used to occupy volume on the back side of the piston to modify the recovery ratio, and that the design of these is not limited to movable concentric shells sleeves or volumes, e.g. a square shaft which couples to the movement of the shaft and is sealed within the piston cylinder can be used to change the relative volumes while not being concentric or even in contact with the shaft; or two parallel shafts can be used, with either one or both shafts in operation; and this concept can be implemented in multiple additional designs.

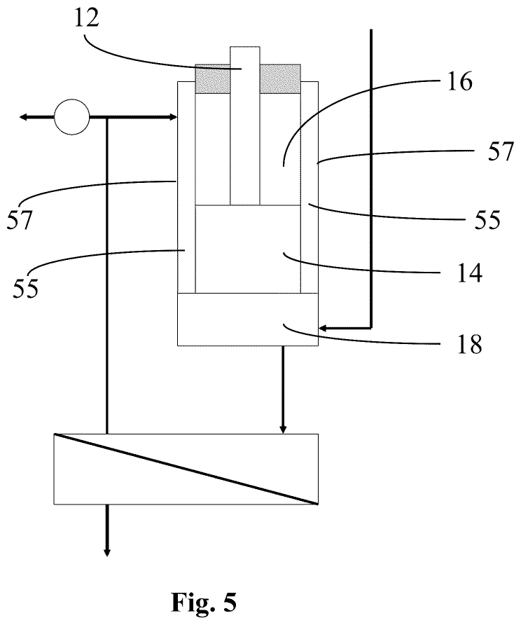

FIG. 5 is a schematic illustration of an example embodiment. A piston 14 slides within an upper chamber 16 (the recovery chamber) formed by inner side walls 55. The inner side walls 55 slidably mount within outer side walls 57. If the inner side walls 55 are fixed to the outer side walls 57, then the effective diameter of the piston 14 in the lower chamber 18 in the figure is just the diameter of the face of the piston 14. If the inner side walls 55 are fixed to the piston 14 or piston shaft 12, then the effective diameter of the piston 14 in the lower chamber is the diameter of the piston 14 increased by the thickness of the inner side walls 55, changing the force on the piston 14 in the lower chamber 18 (the pumping chamber) correspondingly.

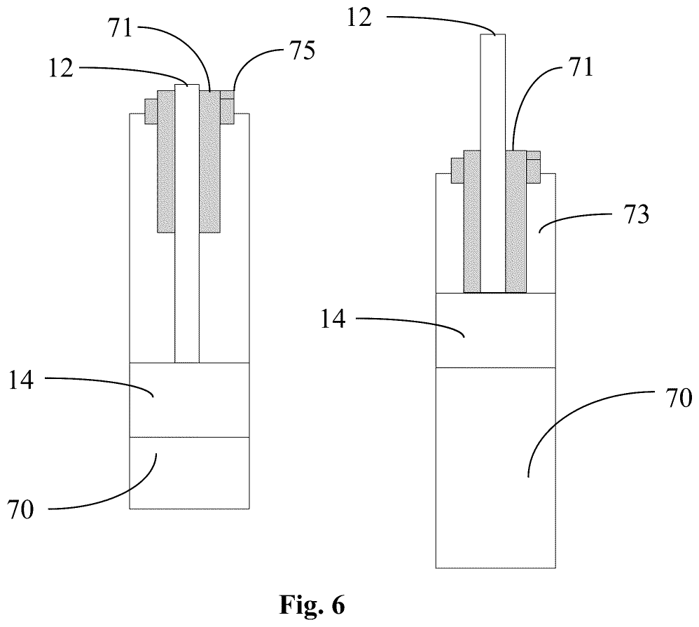

FIG. 6 is a schematic illustration of an example embodiment. A piston 14 is moved by a piston shaft 12 within a chamber 70. A sleeve 71 moves with the piston 14 when the piston 14 is in the upper region of a range of motion (as shown in the configuration on the right in the figure). The effective diameter of the piston 14 in the upper chamber 73 is reduced by the sleeve 71 when the piston 14 is in the upper portion of its range of motion. When the piston 14 is in a lower portion of its range of motion (as shown in the configuration on the left in the figure), the sleeve 71 is retained 75 and prevented from moving with the piston 14, so the effective diameter of the piston 14 is not reduced by the sleeve 71 when moving in the lower portion of the piston's 14 range of motion. The recovery ratio can thus be selected by selecting which portion of the piston's 14 range of motion to operate.

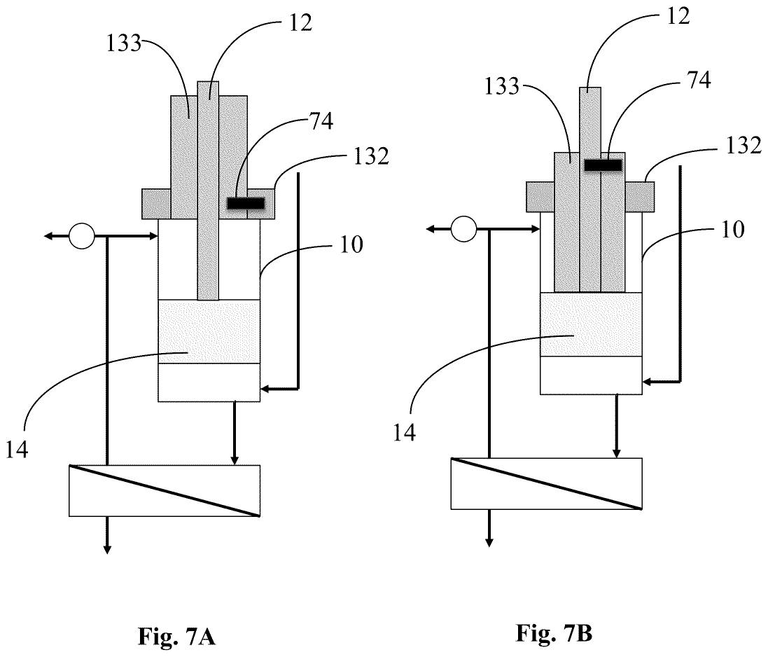

In embodiments where a sleeve is coupled to a piston shaft, a bushing, or another sleeve, various mechanisms of mechanical engagement known in the art can be suitable. FIG. 7A and FIG. 7B are schematic illustrations of an example embodiment illustrating coupling of a sleeve 133 to a bushing 132 (FIG. 7A) or a piston shaft 12 (FIG. 7B). In FIG. 7A, the sleeve 133 is pinned 74 to the housing 10 and bushing 132. The piston 12/14 slides in the sleeve 133. This example provides low permeate recovery and high energy recovery, for a high TDS application. In FIG. 7B, the sleeve 133 is pinned 74 to the piston shaft 12 and the sleeve 133 slides in the housing 10 and bushing 132. The piston 14 and shaft 12 slide together. This example provides high permeate recovery and low energy recovery, for a low TDS application. A keyed twist of the shaft 12/sleeve 133/bushing 132 relative to one another can be suitable for selectively coupling the elements, as can a threaded arrangement or separate pins 74 (one to couple/uncouple the shaft 12 to the sleeve 133 and another to couple/uncouple the sleeve 133 to the bushing 132).

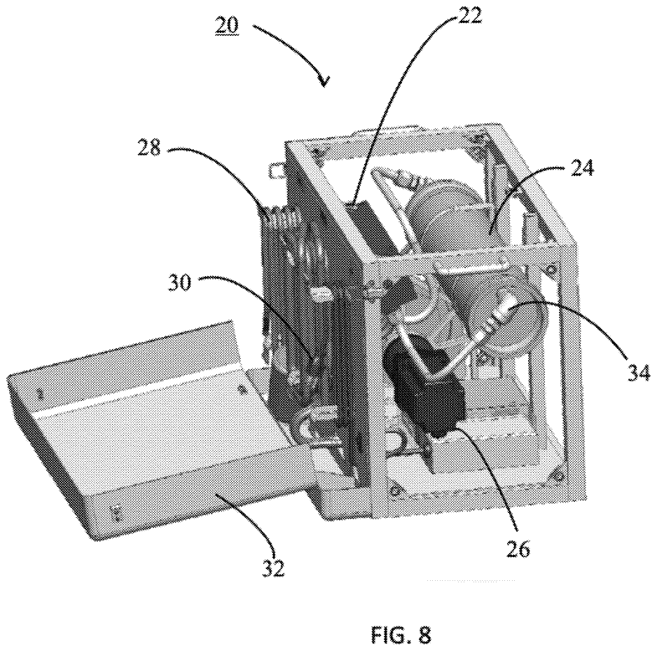

FIG. 8 is an illustration of an example embodiment of a treatment system incorporating a pump as described above. In a package sized for easy portability, this example system can deliver 300 gallons of potable water per day in a system size of approximately 24 inches×16 inches×12 inches, and weighing less than 80 pounds. System 20 can be housed in a frame for easy transport. Pump head 22 comprises a pump as described above. Pump head 22 can be constructed of (as examples) stainless steel, titanium, or suitable high strength injection molded plastic for glass reinforced plastics. The piston and shaft can be constructed of similar materials and seals made of appropriate elastomers such as Viton, Buna N, or other suitable materials. The housing frame can be constructed of steel, aluminum, titanium, or composite high strength plastics. Pump head 22 is connected via fluid lines 34 to reverse osmosis element housing 24. Reverse osmosis element housing may be constructed of plastic, stainless, titanium, or other suitable materials. The reverse osmosis spiral wound membrane element can be a conventional element as commonly used in the industry, or can be a spiral wound membrane element made with printed feed spacers as manufactured by Aqua Membranes LLC, Albuquerque, NM. Motor drive 26 provides reciprocating power to pump head 22. Supply and discharge hoses 28 can be stored on hose storage mounting devices. Power supply cord 30 can also be stored in mounting brackets. In the storage configuration, storage cover 32 closes to conceal and protect supply and discharge hoses 28 and power cord 30 for transport and storage. Storage cover 32 can be constructed of an appropriate sheet metal, high impact plastic, or fiberglass material suitable for the operating environment and light weight construction.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. A reciprocating piston pump with selectable recovery ratio, comprising:
(a) a chamber element, comprising first and second ends, and walls that extend between the first and second ends and enclose a substantially constant chamber cross-section, where the first end has an opening therethrough and a fluid transfer port; and the second end has a fluid input port and a fluid output port;
(b) a sleeve disposed within the first end opening, where the sleeve substantially seals with the first end opening while allowing the sleeve to slide through the first end opening along an axis parallel with the walls, where the sleeve has an opening through the sleeve parallel to the axis;
(c) a piston disposed within the chamber element, having an outer cross-section that substantially seals with the walls while allowing the piston to slide parallel to the walls; wherein the piston has a first face, nonparallel to the walls, that faces the first end of the chamber element, and a second face, nonparallel to the walls, that faces the second end of the chamber element;
(d) a piston shaft disposed within the sleeve opening, where the piston shaft seals with the sleeve opening while allowing the piston shaft to slide through the sleeve;
(e) wherein the piston is fixed to the piston shaft, and wherein the sleeve is selectively configurable to be (1) fixed to the piston shaft with the sleeve sealed with the first face of the piston or (2) fixed with the sleeve spaced apart from the first face of the piston.

2. The reciprocating piston pump of claim 1, further comprising a locking element selectively configurable between a first configuration wherein the locking element fixes the piston shaft to the sleeve with the sleeve in contact with the first face of the piston such that the sleeve slides through the first end opening and the piston shaft does not slide relative to the sleeve opening, and a second configuration wherein the locking element fixes the sleeve with the chamber such that the sleeve does not slide relative to the first end opening and the piston shaft slides within the sleeve opening.

3. The reciprocating piston pump of claim 1, comprising a locking element selectively configurable between a first configuration wherein the locking element fixes the piston shaft to the sleeve with the sleeve in contact with the first face of the piston such that the sleeve slides through the first end opening and the piston shaft does not slide relative to the sleeve opening, and a second configuration wherein the locking element fixes the piston shaft to the sleeve with the sleeve spaced apart from the first face of the piston such that the sleeve slides through the first end opening and the piston shaft does not slide relative to the sleeve opening.

4. The reciprocating piston pump of claim 2, wherein the locking element is a pin.

5. The reciprocating piston pump of claim 2, where the locking element is a mechanical or electro-mechanical engaging mechanism.

6. The reciprocating piston pump of claim 3, wherein the locking element is a pin.

7. The reciprocating piston pump of claim 3, where the locking element is a mechanical or electro-mechanical engaging mechanism.

8. The reciprocating piston pump of claim 1, wherein the piston has a cylindrical shape, the piston shaft has a cylindrical shape, and the sleeve has a cylindrical shape.

9. A system comprising a frame, a reciprocating piston pump as in claim 1 mounted with the frame; a reverse osmosis element in fluid communication with the reciprocating piston pump; and a motor drive configured to drive the reciprocating piston pump.
